(19) United States
(12) Patent Application Publication
(10) Pub. No.: US 2007/0277802 A1
(43) Pub. Date: Dec. 6, 2007

(54) Cookware safety lock device

(76) Inventors: Charlton Reed, Stone Mountain, GA (US); Greg Tzevelekos, Cumming, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/438,232

(22) Filed: May 22, 2006

(51) Int. Cl. F24C 3/12; F24C 15/10; A47J 27/02; F24C 15/20

(52) U.S. Cl. 126/42; 126/376.1; 126/214 D; 126/299 D; 126/211

(57) ABSTRACT

A cookware safety lock device for installation on a stovetop, wherein a heat-resistant base is secured to the stovetop with height-adjustable, pivotable arms extending therefrom, wherein the heat-resistant movable arms accommodate virtually any size pot or pan by locking into position thereabout, and wherein handle ports are defined therein for directing and retaining cookpot handles in a selected position, thereby preventing unintentional and/or unauthorized access thereto.

### FIELD OF THE INVENTION

The present invention relates generally to stove guards, and more particularly to a cookware safety lock device for installation on a stovetop, wherein heat-resistant movable arms securely retain cookware in a selected position, wherein the arms are height adjustable to facilitate accommodation to virtually any size pot or pan, and wherein the arms are pivotable to enable easy adjustment about the work surface.

### BACKGROUND OF THE INVENTION

Kitchens are filled with potentially dangerous tools. Accidents can quickly occur, whether via unintentional contact with sharp knives or cutting blades, or inadvertent touching of heated surfaces, pans or pots. As such, much care is typically exercised when performing cooking and/or food preparation chores. Even so, accidental overturning of boiling pots, for example, injures scores of individuals each year.

Inherently, however, cooking often involves potentially lengthy periods of time, while food is cooking, that does not require continued presence in the kitchen, wherein timers are commonly utilized in order to provide notification for timely return. As a result, it is not uncommon for food to cook without the direct supervision of the cook, both in an oven and on a cooktop, for certain segments of time. Although the cook is not susceptible to accidental kitchen injuries during this period, others, especially children, individuals with special needs, senior citizens, and even pets, are placed at greater risk of potential injury via contact with burning hot, unsupervised surfaces, cookware and the content thereof.

As such, devices have been suggested in order to protect individuals from unintended contact with hot surfaces and/or hot cookware. Each, however, is disadvantageous in view of the present invention. One such device, for example, is attached to a stovetop, encircling the diameter of a cookpot in order to retain same. While potentially effective for preventing accidental spillage of some pots, the need to encircle the base of the pot prevents use of the device with larger diameter pans. Another type of protective device is an immovable cooktop guard that forms a barricade about a cooktop in order to prevent accidental contact therewith. Although potentially effective for such purpose, intended access to cooking contents can also hindered, rendering use of such a guard unpleasant for the cook. Further, because pots are not secured in position thereby, accidental spills could still occur.

Therefore, it is readily apparent that there is a need for a cookware safety lock device for installation on a stovetop, wherein heat-resistant movable arms securely retain cookware in a selected position, wherein the arms are height adjustable to facilitate accommodation to virtually any size pot or pan, and wherein the arms are pivotable to enable easy adjustment about the work surface, thereby avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a cookware safety lock device, wherein virtually any diameter or depth cookpot may be restrained in a selected position, wherein quick and easy access to the cookpot for subsequent, authorized movement thereof is facilitated, and wherein accidental and/or unauthorized contact with a pot, pan or hot stovetop is prevented via heat-resistant, guard-style components.

According to its major aspects and broadly stated, in its preferred form, the present invention is a cookware safety lock device for installation on a stovetop, wherein a heat-resistant base is secured to the stovetop with height-adjustable, pivotable arms extending therefrom, wherein the heat-resistant movable arms accommodate virtually any size pot or pan by locking into position thereabout, and wherein handle ports are defined therein for directing and retaining cookpot handles in a selected position, thereby preventing unintentional and/or unauthorized access thereto.

More specifically, the device of the present invention in its preferred form is a cookware safety lock device defined by locking arms and a support structure therefore, wherein all components are formed from heat-resistant and/or insulated materials. The locking arms extend from the support structure proximate a stove or rangetop surface in a manner that facilitates height adjustment of the arms relative to the cooktop surface in order to accommodate and lock pots and pans ranging from shallow, small diameter omelet pans to deep, large diameter stock pots.

Pivot points are provided at a plurality of locations on each arm, thereby further maximizing accommodating adjustability for cookware, and also facilitating access to the stovetop surface during placement of cookware. Further, pot handle receiving ports are defined in the locking arm, thereby facilitating not only the locking of the location of a pot, but also of the relative positioning of the handle thereof.

In the preferred configuration, the support structure is a base that is adapted for secure attachment to a stove or range, such that the locking arms of the device are accessible at the stove or rangetop surface, proximate the burners. However, the device may be permanently or removably attached, may be integrally formed, or may be retractably installed, either proximate a stovetop or freestanding range.

Thus, a feature and advantage of the present invention is its ability to be quickly, easily and securely positioned.

Another feature and advantage of the present invention is its ability to be inexpensively manufactured.

Another feature and advantage of the present invention is its ability to prevent accidents, injuries and fires while cooking is taking place on a stovetop.

Yet another feature and advantage of the present invention is its ability to lock pots and pans in place during their use for cooking.

Yet another feature and advantage of the present invention is its ability to adjustably accommodate virtually any size or shape cookware.

Still another feature and advantage of the present invention is that it is an ideal, easy-to-use, and affordable safety item for anyone who cooks.

Still yet another feature and advantage of the present invention is its ability to be easily stored away.

Yet still another feature and advantage of the present invention is its ability to prevent children from pulling down hot cookware from a stove.

Yet still another feature and advantage of the present invention is its ability to minimize risk of injury while heating, boiling, frying, roasting, and/or steaming.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a frontal view of a cookware safety lock device, according to the preferred embodiment of the present invention;

FIG. 2 is a frontal view of a cookware safety lock device, according to an alternate embodiment of the present invention;

FIG. 3 is a frontal view of a cookware safety lock device, according to an alternate embodiment of the present invention;

FIG. 4 is a frontal view of a cookware safety lock device, according to an alternate embodiment of the present invention;

FIG. 5 is a cross-sectional view of a cookware safety lock device according to an alternate embodiment of the present invention;

FIG. 6 is a cross-sectional view of a cookware safety lock device according to an alternate embodiment of the present invention;

FIG. 7 is an overhead view of a cookware safety lock device according to an alternate embodiment of the present invention; and

FIG. 8 is an overhead view of a cookware safety lock device according to an alternate embodiment of the present invention.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

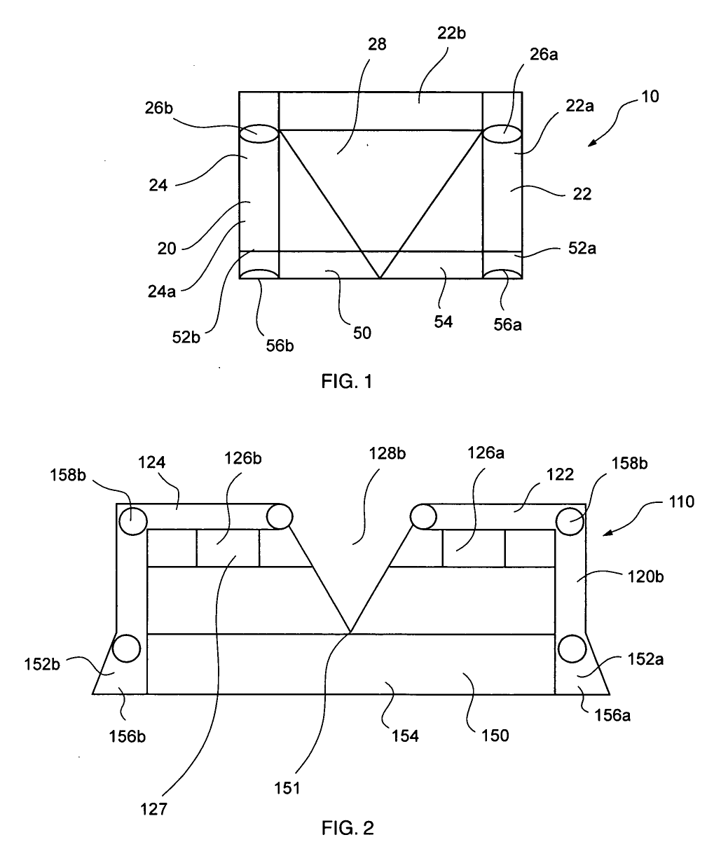

Referring now to FIG. 1, the present invention in the preferred embodiment is cookware safety lock device 10, comprising plurality of locking arms 20 and support structure 50 therefore. Preferably, cookware safety lock device 10 is formed from heat-resistant material, such as, for exemplary purposes only, high-density silicon, stainless steel, or other appropriate material having heat-resistive and non-heat transferring qualities, such that cookware safety lock device 10 is not damaged by heat and also such that the majority of any absorbed heat is not transferred to heat surfaces potentially contacted by individuals. Further, it is preferable that cookware safety lock device 10 be washable, and/or otherwise able to be cleaned and/or sterilized.

Plurality of locking arms 20 preferably includes first arm 22 and second arm 24, wherein first arm 22 and second arm 24 are preferably defined by upright sections 22a and 24b, respectively, and like cross members, wherein cross member 22b of first arm 22 is depicted in FIG. 1, and the cross member of second arm 24 is not shown, but is hidden in FIG. 1 behind cross member 22b of first arm 22. Preferably, handle ports 26a and 26b are respectively defined through upright sections 22a and 24b, wherein handle ports 26a and 26b are preferably dimensioned to receive typically configured and sized pot handles therethrough. Central opening 28 is preferably defined between first arm 22 and second arm 24, wherein central opening 28 is preferably generally triangular-shaped, and wherein pot handles (not shown) may be alternately received therethrough, in lieu of through handle ports 26a and 26b.

Preferably, pivot points 52a and 52b are respectively positioned near the base of upright sections 22a and 24a, wherein first arm 22 and second arm 24 preferably pivot thereabout for selected positioning relative to a cookpot (not shown). Pivot points 52a and 52b are preferably adapted to facilitate positional locking, upon activation of same, wherein such locking could be accomplished, for example, via a ratchet-type mechanism or via a thumb-screw or the like.

In the preferred embodiment, support structure 50 comprises weighted base 54 and skid-pads 56a and 56b, wherein skid-pads 56a and 56b provide a protective surface to prevent potential cooktop surface damage, and wherein weighted base 54 prevents unintentional movement of cookware safety lock device 10. Thus, it is preferable that the weight of weighted base 54 is of a magnitude that renders cookware safety lock device 10 difficult to lift or move.

Referring now to FIG. 2, an alternately configured cookware safety lock device 110 is shown, comprising plurality of locking arms 120 and support structure 150 therefore. Plurality of locking arms 120 includes first arm 122 and second arm 124, wherein first arm 122 and second arm 124 define inverted “L”-shapes. Handle ports 126a and 126b are respectively defined and dimensioned to receive typically configured and sized pot handles therethrough. Handle ports 126a and 126b could be adapted to facilitate closure when not in use, such as via a slidable or hinged window-like coverings 127. Central opening 128 is also defined between first arm 122 and second arm 124, wherein central opening 128 is generally triangular-shaped, and wherein pot handles (not shown) may be alternately received therethrough, in lieu of through handle ports 126a and 126b.

Pivot points 152a and 152b are respectively positioned near the base of first arm 122 and second arm 124, wherein first arm 122 and second arm 124 pivot thereabout for selected positioning relative to a cookpot (not shown). Pivot points 152a and 152b are adapted to facilitate positional locking, upon activation of same, wherein such locking could be accomplished, for example, via a ratchet-type mechanism or via a thumb-screw or the like. Further, elbows 158a and 158b of first arm 122 and second arm 124, respectively, could also pivotally function, and could also lock into place, such as at snap-lock point 151, whereby additional adaptability about a potentially larger variety of cooking implements could be enabled.

Alternate support structure 150 comprises elongated base member 154 and magnetic foot members 156a and 156b, wherein magnetic foot members 156a and 156b provide for secure, yet removable positioning on metal cooktop surface. Elongated base member 154 could provide maximized protection with minimized obstruction at a height of four inches, however, it is recognized that any height base, greater or less than four inches, could be utilized. Magnetic foot members 156a and 156b possess magnetic strength of a magnitude that prevents unintentional movement of cookware safety lock device 110, thus rendering cookware safety lock device 110 difficult to lift or move. For use in combination with non-metallic cooktop surfaces, magnets could be secured to the cooktop, via adhesive, screw, or other suitable means, wherein cookware safety lock device 110 could be installed thereon.

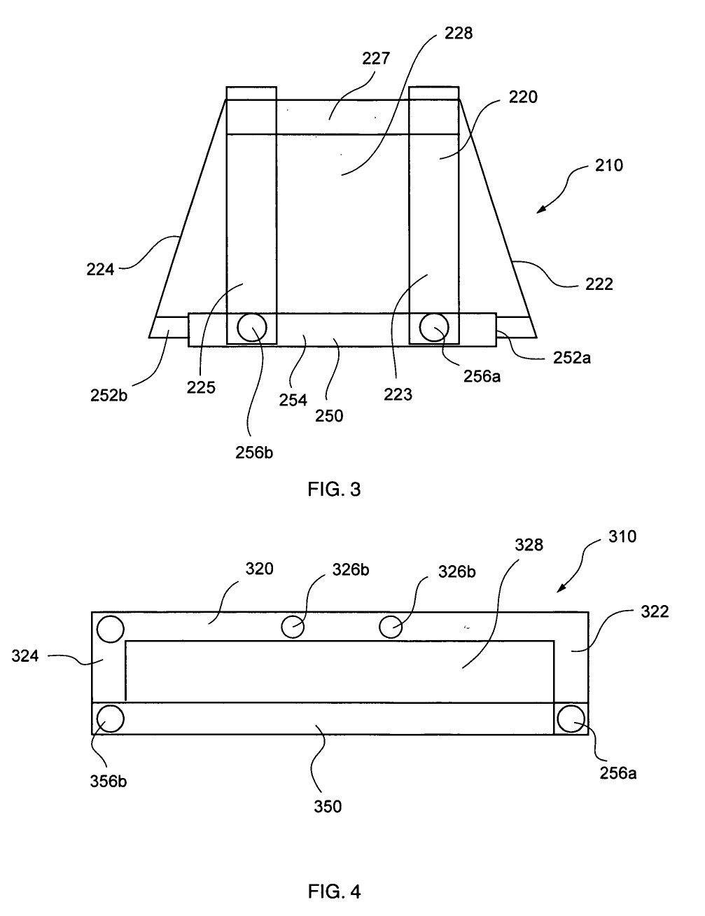

Referring now to FIG. 3, another alternately configured cookware safety lock device 210 is shown, comprising plurality of locking arms 220 and support structure 250 therefore. Plurality of locking arms 220 includes first arm 222 and second arm 224, wherein first arm 222 and second arm 224 define an angled extension toward uprights 223 and 225 and cross member 227 therebetween. Central opening 228 is defined between first arm 222 and second arm 224, wherein central opening 228 is generally rectangular-shaped, and wherein pot handles (not shown) may be received therethrough.

Pivot points 252a and 252b are respectively positioned near the base of first arm 222 and second arm 224, wherein first arm 222 and second arm 224 pivot, or hinge, thereabout for selected positioning relative to a cookpot (not shown). Pivot points 252a and 252b are adapted to facilitate positional locking, upon activation of same, wherein such locking could be accomplished, for example, via a ratchet-type mechanism or via a thumb-screw or the like. It is envisioned that uprights 223 and 225 could be adjustably mounted on support structure 250, wherein the width between upright 223 and upright 225 could be slidably adjusted and locked, as desired.

Alternate support structure 250 comprises base member 254 and attachment members 256a and 256b, wherein attachment members 256a and 256b could be bolts, screws, or any suitable fastener for securely mounting the device of the present invention to a cooktop surface, either removably or permanently.

Referring now to FIG. 4, another alternately configured cookware safety lock device 310 is shown, comprising elongated locking arm 320 and attachment members 356a-b, wherein support structure 350 therefore is the cooktop surface. Locking arm 320 defines an elongated U-shape, with height adjustable first arm 322 and height adjustable second arm 324. Handle ports 326a and 326b are respectively defined and dimensioned to receive typically configured and sized pot handles therethrough. Central opening 328 is also defined under the elongated U-shape of locking arm 320, wherein central opening 328 is generally rectangular-shaped, and wherein pot handles (not shown) may be alternately received therethrough, in lieu of through handle ports 326a and 326b. Attachment members 356a and 356b could be bolts, screws, or any suitable fastener for securely mounting the device of the present invention to a cooktop surface, either removably or permanently.

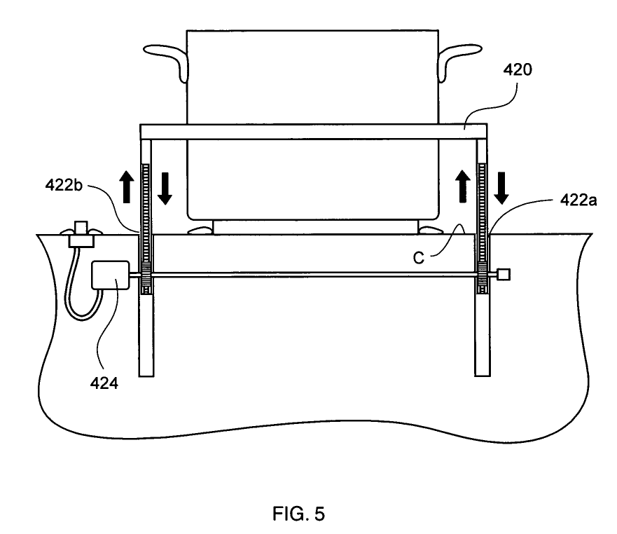

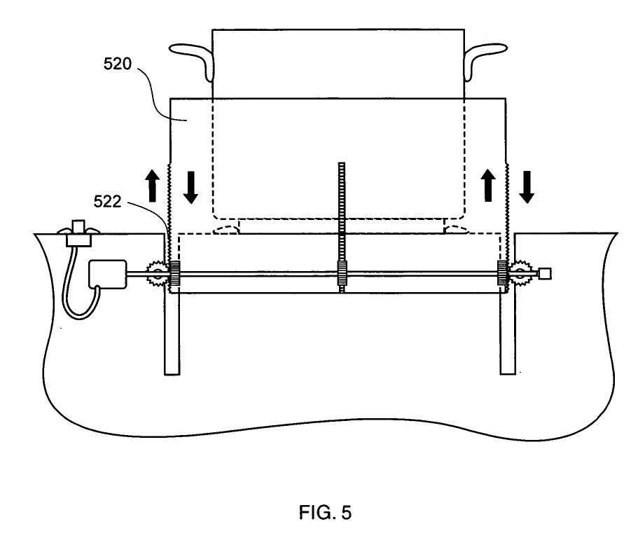

In another alternate embodiment, referring to FIG. 5, plurality of locking arms 420 of the present invention could be secured within recessed compartments 422a and 422b below the surface of the cooktop C, wherein a mechanized lift system, via motorized element 424, could facilitate automatic ejection of locking arms 420 from below the cooktop surface, and selectable lowering following use. In such a manner, the present invention could be hidden from view when not in use. Alternately, in lieu of motorized element 424, locking arms 420 could be adapted much like an airline tray-table stowed within the arm of a bulkhead or first-class seat, wherein non-powered, hinged retrieval thereof could be facilitated.

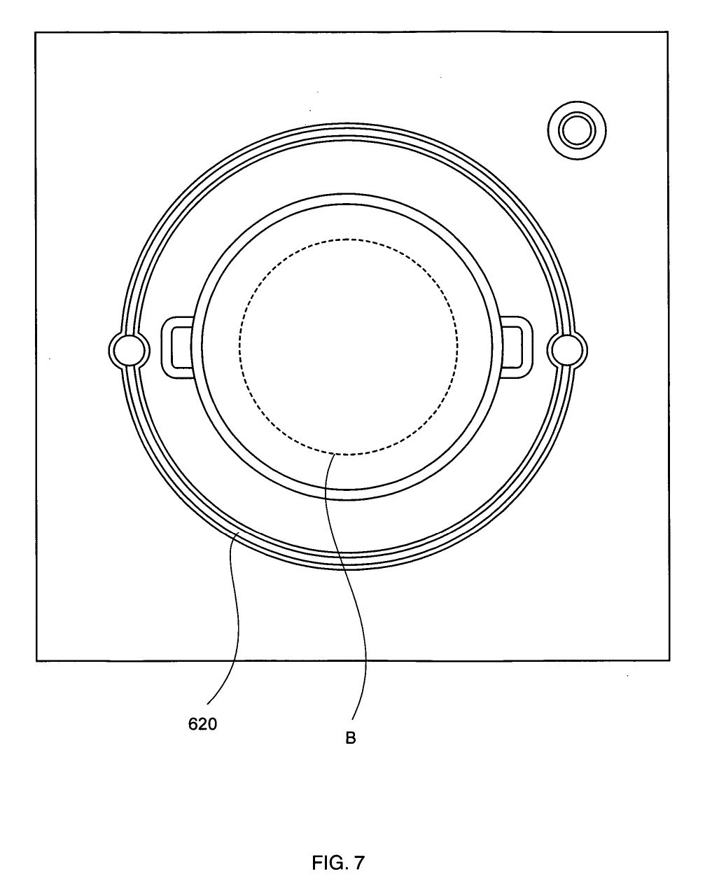

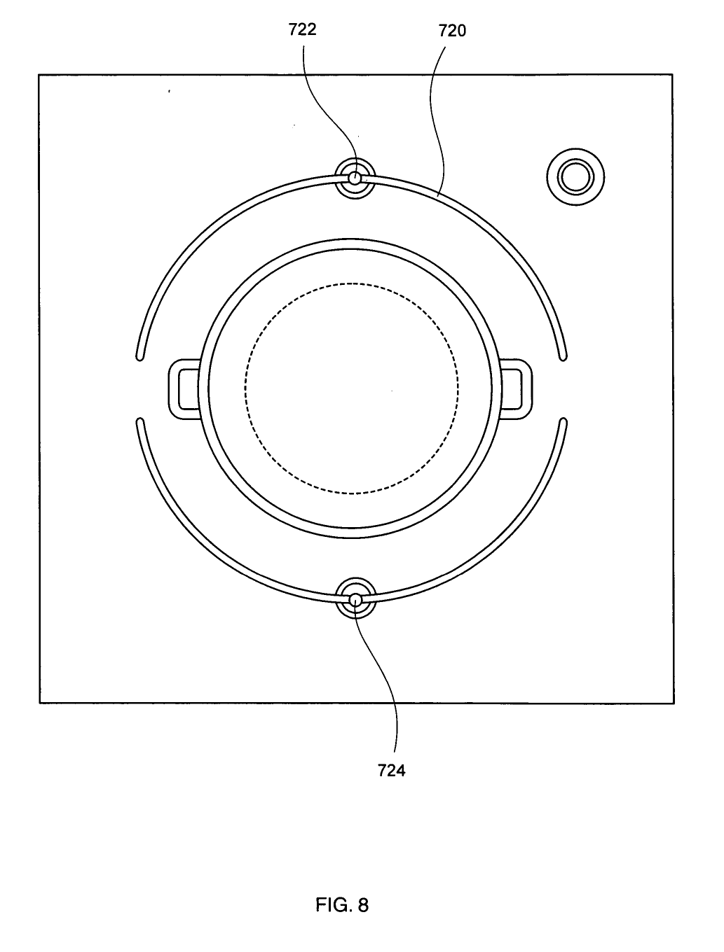

In another alternate embodiment, depicted in FIG. 6, generally solid panel 520 could be secured within generally elongated recessed compartment 522, wherein selective mechanized or non-mechanized adaptation of solid panel 520 could facilitate raising and/or lowering, as desired.

In still another alternate embodiment, any and all of the foregoing could be adapted with height-adjustment features, such as via the incorporation of appropriately selectable slidable component members.

In yet still another alternate embodiment, a single, inverted-L shape locking arm member could be utilized without a cross-positioned mate, and without a base, wherein such a single, inverted-L shape locking arm member could function alone.

In still yet another alternate embodiment, the cookware safety lock device of the present invention could be integrally formed within a stove and/or range, wherein the locking arms could extend directly therefrom.

In yet another alternate embodiment, the cookware safety lock device of the present invention could be retractably installed, either via an electronic or simple mechanical mechanism, wherein the retracted state position could be behind an openable door in the stovetop surface, or in the side of the range or countertop, or the retracted device could retract into a recessed area defined therefore.

In still yet another alternate embodiment, as depicted in FIG. 7, rim 620 could retractably surround burner B, in order to facilitate protective encircling of pots having a pre-determined circumference. Alternatively, plurality of arcuate arms 720 could be supported on posts 722 and 724, wherein each post 722 and 724 could be centrally positioned between two arcuate arms 720, thereby defining a generally “C”-shaped protective shield. Each post 722 and 724 could facilitate hinged adjustment of arcuate arms 720 thereabout, thereby enabling selective adjustment about cookware of essentially any diameter.

In the preferred use, when a pot is placed on top of a stove, first arm 22 of plurality of locking arms 20 is preferably extended via pivot point 52a, with cross member 22b positioned proximate to the pot, wherein pivot point 52a is locked into place. Preferably, the pot handle is adjusted to extend through handle port 26a. Thus, contact with the hot stove surface and/or pot is prevented via cookware safety lock device 10, and rotational movement of the pot is prevented by handle port 26a.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A cookware safety lock device, comprising:
at least one pivotable arm,
wherein said at least one pivotable arm is positioned relative to a cooktop, and wherein said at least one pivotable arm is configured to secure the position of a piece of cookware.

2. The cookware safety lock device of claim 1, wherein said at least one pivotable arm is arcuately shaped.

3. The cookware safety lock device of claim 1, further comprising a base.

4. The cookware safety lock device of claim 3, wherein said cookware safety lock device is heat-resistant.

5. The cookware safety lock device of claim 1, wherein said at least one pivotable arm is height adjustable.

6. The cookware safety lock device of claim 1, wherein said at least one pivotable arm further comprises handle ports defined therein.

7. A cookware safety lock device, comprising:
a plurality of locking arms, and
a support structure, wherein said plurality of locking arms extend from said support structure, and wherein said cookware safety lock device is heat-resistant.

8. The cookware safety lock device of claim 7, wherein each said locking arm of said plurality of locking arms further comprises a plurality of pivot points defined therein.

9. The cookware safety lock device of claim 7, wherein each said locking arm of said plurality of locking arms further comprises at least one handle port aperture defined therein.

10. The cookware safety lock device of claim 9, wherein said support structure is removably attached to a stove.

11. The cookware safety lock device of claim 9, wherein said support structure is fixedly attached to a stove.

12. The cookware safety lock device of claim 9, wherein said support structure is integrally formed with a stove.

13. The cookware safety lock device of claim 1, wherein said at least one pivotable arm is retractably carried by a stove.

14. The cookware safety lock device of claim 8, wherein each said pivot point of said plurality of pivot points further comprises a ratchet-style locking mechanism.

15. The cookware safety lock device of claim 1, wherein said at least one pivotable arm further comprises a positional locking mechanism.

16. The cookware safety lock device of claim 3, wherein said base further comprises a weighted base and at least one skid pad.

17. The cookware safety lock device of claim 3, wherein said base further comprises at least one magnet.

18. The cookware safety lock device of claim 3, wherein said base is secured to a cooktop via fasteners selected from the group of: bolts and screws.

19. The cookware safety lock device of claim 11, wherein said stove comprises at least one compartment, wherein said plurality of locking arms hingedly retracts therein.

20. The cookware safety lock device of claim 19, wherein said hinged retraction is mechanized.
